(19) United States
(12) Patent Application Publication
(10) Pub. No.: US 2026/0023029 A1
(43) Pub. Date: Jan. 22, 2026

(54) Method for Determining a Composition of a Component

(71) Applicant: Robert Bosch GmbH, Stuttgart (DE)

(72) Inventor: Heiko Sgarz, Leonberg (DE)

(21) Appl. No.: 19/267,593

(22) Filed: Jul. 13, 2025

(30) Foreign Application Priority Data
Jul. 18, 2024 (DE) 10 2024 206 766.0

(51) Int. Cl. G01N 22/00; G01B 15/02; G01S 7/04; G01S 7/40

(52) U.S. Cl. CPC G01N 22/00; G01B 15/02; G01S 7/04; G01S 7/4021

(57) ABSTRACT

A method for determining a composition of a component includes (i) providing radar data, wherein the radar data results from a detection of a sensor, wherein the sensor is disposed in an area of the component and emits a radar signal towards the component for the detection, (ii) selecting an analysis method for determining the composition of the component as a function of a thickness of the component, and/or a number of layers, and/or a thickness of the layers of the component, and (iii) determining the composition of the component using the selected analysis method. The selected analysis method for determining the composition of the component includes (i) detecting at least one reflection based on the provided radar data, (ii) determining a permittivity and a thickness of at least one layer of the component based on the detected at least one reflection, and (iii) providing a description of the at least one layer of the component based on the determined permittivity and thickness. A computer program, an apparatus, a storage medium and a locating device for this purpose are also disclosed.

This application claims priority under 35 U.S.C. § 119 to application no. DE 10 2024 206 766.0, filed on Jul. 18, 2024 in Germany, the disclosure of which is incorporated herein by reference in its entirety.

The disclosure relates to a method for determining a composition of a component. The disclosure further relates to a computer program, an apparatus, a storage medium and a locating device for this purpose.

### BACKGROUND

Locating devices, particularly radar locating devices, may locate objects in components such as walls, ceilings, or floors. This information may be helpful to avoid objects being drilled into and avoiding greater damage being done in this case. However, in the prior art, the locating devices are in particular limited to locating the objects and no information is determined about a structure of the component itself.

In some countries, it is mandatory to have an expert opinion prepared when selling a property. A composition or construction of components plays an important role in such opinions. Currently, this composition needs to be determined in some cases in a destructive manner, by drilling holes and conducting visual inspections with inspection cameras.

### SUMMARY

The subject of the disclosure is a method, a computer program, a device, a computer-readable storage medium, and a camera system having the features set forth below. Further features and details of the disclosure will emerge from the description and the drawings. Features and details which are described in connection with the method according to the disclosure naturally also apply in connection with the computer program according to the disclosure, the apparatus according to the disclosure, the computer-readable storage medium according to the disclosure as well as the locating device according to disclosure, and vice versa in each case, so that a reciprocal reference is always possible with regard to the disclosure of the disclosure.

The subject matter of the disclosure is in particular a method for determining a composition of a component, comprising the following steps, wherein the steps can be repeated and/or performed sequentially. The component can be, for example, a wall, a ceiling or a floor, for example in a building. The composition may also be referred to and understood as a structure, and in a simplified manner, designates how many layers the component is constructed from and how thick each of these layers are.

In a first step, preferably, radar data is provided, wherein the radar data results from a detection of a sensor, wherein the sensor is disposed in a range of the component and emits a radar signal towards the component for the detection. The sensor is in particular a radar sensor. The radar sensor may be used in that it emits electromagnetic waves and receives the reflected waves. In particular when an object is in proximity to the sensor, a portion of the transmitted waves are reflected by the object and directed back to the sensor. The sensor then preferably senses the reflected waves and may determine positions and magnitudes of objects based on a travel time and strength of the reflected signals. The sensor may be part of the locating device according to the disclosure, which may also comprise the display described below. The fact that the sensor is disposed in a range of the component may, in particular, indicate that the sensor is in proximity to the component. For example, the locating device may be applied to the component, for example against a surface of the component.

In a further step, an analysis method for determining the composition of the component as a function of a thickness of the component and/or a number of layers and/or a thickness of the layers of the component is preferably selected. For example, these parameters of the thickness of the component and/or the number of layers and/or the thickness of the layers of the component may be known and predefined based on a prior knowledge, and/or there may be an approximate idea of these parameters. Alternatively, a random or free selection of the analysis method can be carried out if there is no prior knowledge of these parameters. It is also contemplated that the first analysis method will always be selected or the second analysis method will always be selected if there is no prior knowledge of these parameters. In this way, an analysis method that is advantageously suitable for the given circumstances can be provided that is sufficiently precise and does not require an unnecessarily high computational effort. In particular, the first or the second analysis method listed below is selected. With regard to the second analysis method according to the disclosure, the difficulty may arise that many parameters must be considered at once. This can therefore be more suitable for cases in which preliminary information regarding the composition of the component is already available and concerns only a few layers. In addition, it may be advantageous if the composition of the component contains thin layers such that they can no longer be resolved by the sensor. This may be problematic for the first analysis method according to the disclosure. Based at least on these aspects, one of the analysis methods may be selected, wherein the list is not exhaustive.

In a further step, the composition of the component is preferably determined using the selected analysis method. The selected analysis method for determining the composition of the component preferably comprises the following steps:
detecting at least one reflection based on the provided radar data,
determining a permittivity and a thickness of at least one layer of the component based on the detected at least one reflection,
providing a description of the at least one layer of the component based on the determined permittivity and thickness.
   In this context, a time difference between reflections and a propagation speed as a function of the permittivity is also preferably taken into account as part of the selected analysis method. For example, the description of the composition includes a number of layers, a thickness of the respective layers, a permittivity of the respective layers, and/or a material of the respective layers. Thus, the composition of the component can advantageously be determined in a differentiated manner based on the radar signal in a non-destructive manner.

It is possible that the method further comprises the following step:
Initiating a display of the determined summary on a display, wherein the display comprises at least the thickness of the component and/or the number of layers and/or the thickness of the layers of the component, wherein the display preferably further comprises a permittivity of a respective layer and/or a material of the respective layer determined based on the permittivity.
   This function may advantageously allow users to visualize the composition of the component and obtain a clear and easy to understand representation of the component cross-section, i.e., of the composition. This representation may allow for a quick understanding and analysis of the composition of the component. Moreover, the display may also provide information on permittivity, which may be helpful in determining the electrical properties of the layers of the component. The representation may also facilitate comparison and analysis between different components or structures so that the user can recognize patterns, trends, and correlations. Further, the ability to visualize the composition of components may also allow for the identification of potential problems or problem areas, such as damaged or degraded materials, which may be important, for example, for ensuring public safety and avoiding costly repairs or replacement investments.

It is further contemplated that a first analysis method for the selection, or a first analysis method that may be selected as part of the selection, comprises the steps of:
determining a reflection of a first layer of the component, in particular by an analysis of the radar data, wherein the reflection may be expressed by an increased signal strength in the radar data,
determining a permittivity of the first layer based on the determined reflection,
determining a time difference between the first and a second reflection, in particular by an analysis of the radar data, wherein the second reflection may be expressed in the radar data by a further increased signal strength which is later in time with respect to the first reflection,
determine a thickness of the first layer based on the determined permittivity and the determined time difference,
removing a fraction of the radar data representing the first layer by determining scattering parameters of the first layer based on the determined permittivity and thickness of the first layer and then subtracting them from concatenated scattering parameters of the radar data to obtain radar data representing the composition of the component without the first layer.
   The steps may be repeated for further layers of the component until a defined termination criterion is met. The permittivity is in particular determined by emitting a radar signal and receiving the reflected signal, measuring a travel time of the signal and analyzing the reflection coefficients. The permittivity can then be calculated based on the measured travel time and signal strength.

The scattering parameters describe in particular how incoming signals on network ports are converted into reflected and permeable signals, in particular wherein the locating device used comprises these ports. For example, for a network with n ports, there are a total of n² scattering parameters. For example, scattering parameters for a two-gate network are as follows: S11 (reflection factor): In particular, this indicates a ratio of reflected power to incoming power on port 1. S21 (transmission factor): In particular, this indicates a ratio of the power received at port 2 to the power supplied at port 1. S12 (transmission factor): In particular, this indicates a ratio of the power received at port 1 to the power supplied at port 2. S22 (reflexion factor): In particular, this indicates a ratio of reflected power to incoming power on port 2. Scattering parameters may be used to analyze an interaction of a radar signal with objects or materials. This may include, for example, an analysis of the reflected signals to obtain information about the surface or structure of the object. Further, the signals passing through the material may be examined to determine the permittivity. In addition, the distribution of the reflected and scattered signals may be investigated to characterize a shape and characteristic of objects.

For example, the scattering parameters are measured using a vector network analyzer (VNA). This in particular sends a signal to the network and measures the reflected and transmitted signals on the various ports. The S parameters are then preferably presented as functions of the frequency.

It can further be provided that a material of the respective layer is additionally determined based on the determined permittivity. The determined permittivity may advantageously be used to determine the material, because each material has a specific permittivity. Accordingly, a corresponding assignment can be made based on the determined permittivity, for example using a reference table.

The termination criterion may be a predefined maximum number of layers and/or a criterion depending on a size of the remaining radar data after deduction of all previously analyzed layers. The termination criterion may advantageously enable more efficient processing and less computational effort.

In addition, a second analysis method for selecting, or a second analysis method that may be selected as part of the selection, may comprise the steps of:
defining a starting point, wherein the starting point is a presumed composition of the component with a defined number of layers with respective permittivity thicknesses of the layers,
calculating scattering parameters of each layer and concatenating the calculated scattering parameters to obtain theoretical radar data of the starting point,
comparing the theoretical radar data with the provided radar data to determine an error,
determining a direction of travel based on the determined error, wherein the direction of travel represents a change in the starting point resulting in a reduction in the error.
   The steps can be carried out until the error falls below a defined maximum. The presumed composition of the component, i.e., the starting point, may be defined randomly or based on a previous knowledge of the component. The scattering parameters may be calculated as described above. In other words, this method is used to iteratively determine the composition of the component by adjusting the starting point based on the comparison between theoretical and actual radar data. By repeatedly adjusting the starting point and comparing the theoretical and actual radar data, the correct composition of the component can be determined using the second analysis method.

Further, it is contemplated that multiple starting points will be defined and a respective error of the defined starting points will be calculated, wherein beginning from a starting point of the smallest calculated error, the steps of calculating the scattering parameters, comparing the theoretical radar data with the provided radar data and determining the direction of travel are performed until the error falls below the defined maximum. Thus, it is advantageously possible to start with several possible presumed compositions of the component in parallel, whereby the actual composition of the component can be determined significantly more quickly.

Also, optionally, providing the radar data may comprise the steps of:
detecting the radar data using the sensor, wherein the sensor is disposed in an area of the component and emits the radar signal towards the component for detection,
analyzing the detected radar data to perform object detection in the component,
discarding the detected radar data when a result of the analysis indicates that an object has been detected.
   Thus, using distorted radar data to determine the composition of the component may advantageously be avoided, since an object in the component may lead to distortions and thus to altered radar data.

It is also contemplated that providing the radar data comprises the steps of:
detecting the radar data using the sensor, wherein the sensor is arranged sequentially in at least two positions in a range of the component and transmitting the radar signal towards the component for detection at the respective position,
calculating a mean and/or a median for the radar data detected at the at least two positions.
   In this way, individual measurement errors may be eliminated because the mean or median may be calculated to obtain a more representative result. In addition, advantageously, impacts of object effects that might have influenced individual measurements may be reduced. Further, the robustness may additionally be increased, inter alia by reducing the noise.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

The disclosure may also relate to a locating device for determining a composition of a component comprising at least one sensor and a display. The locating device may be configured to perform the method according to the disclosure. The at least one sensor is in particular a radar sensor. Further, the locating device may comprise a position sensor, for example to detect the radar data in sequence at the at least two positions on the component.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a locating device with a sensor and a display, a data processing device, a storage medium and a computer program according to exemplary embodiments of the disclosure,

FIG. 2 a schematic illustration of a locating device having a sensor and a display, as well as a component having multiple layers.

### DETAILED DESCRIPTION

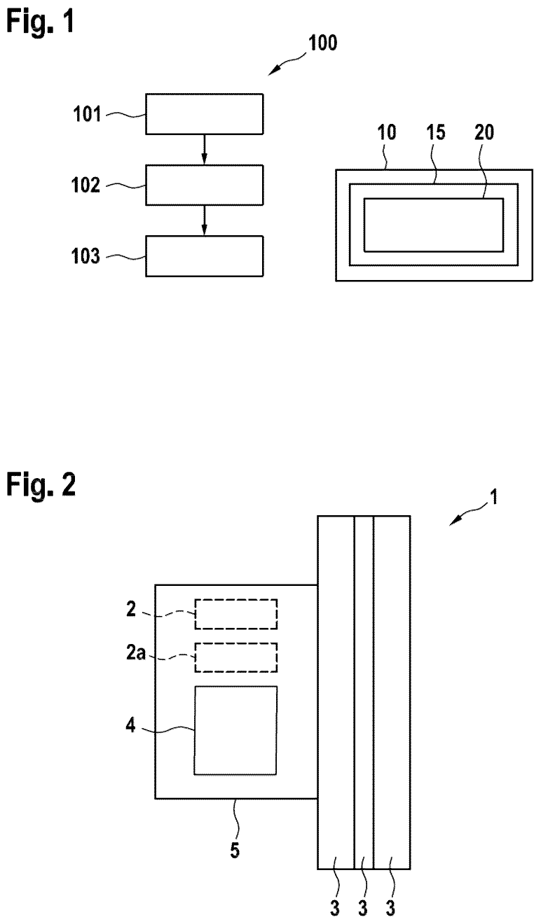

FIG. 1 schematically illustrates a method 100, a data processing device 10, a storage medium 15, and a computer program 20 according to exemplary embodiments of the disclosure.

In particular, FIG. 1 shows a method 100 for determining a composition of a component 1. In a first step 101, radar data is provided, wherein the radar data results from a detection of a sensor 2, wherein the sensor 2 is disposed in a range of the component 1 and emits a radar signal towards the component 1 for the detection. In a second step 102, an analysis method for determining the composition of the component 1 is selected as a function of a thickness of the component 1 and/or a number of layers 3 and/or a thickness of the layers 3 of the component 1. In a third step 103, the composition of the component 1 is determined using the selected analysis method. The selected analysis method for determining 103 the composition of the component 1 comprises the steps of:
detecting at least one reflection based on the provided radar data,
determining a permittivity and a thickness of at least one layer 3 of the component 1 based on the at least one detected reflection,
providing a description of the at least one layer 3 of the component 1 based on the determined permittivity and thickness.

FIG. 2 schematically shows a locating device 5 having a sensor 2 configured as a radar sensor, a position sensor 2a, and a display 4 according to exemplary embodiments of the present disclosure. The locating device 5 is disposed on a component 1, which comprises a plurality of layers 3.

In some applications, in addition to locating objects, it may be necessary to obtain information about a composition, in particular a construction or cross section of components such as walls, ceilings or floors. Specifically, this may be a thickness of the components, for example, in order to be able to select a correct tool or assess statics. Further, a thickness of insulating layers may be determined to perform an energy assessment or a thickness of floating screed may be determined to evaluate a mechanical resiliency.

According to exemplary embodiments, the disclosure describes a method by which information about a composition, in particular a cross-section, of a component can be obtained from radar data in a non-destructive manner and displayed. Further, according to exemplary embodiments, a locating device is described having a radar sensor, a data processing device, a display, and optionally a position sensor. The function according to exemplary embodiments may also be integrated into a radar locating device. There is, for example, the advantage that at least parts of the necessary hardware are already present.

The following section describes a determination of the composition of the component according to exemplary embodiments. First, it may be necessary to collect suitable radar data that is representative of the composition of the component. There may be positions on the component without the influence of objects. These are particularly suitable for determining the composition of the component. The influence of objects may falsify the determination of the composition of the component. For example, however, it is generally unknown whether radar data is affected by a particular position of objects. There are various ways to obtain the desired, uninfluenced radar data. Radar data influenced by objects may be detected (locating function), and this radar data may be discarded for the function of determining the composition of the component considered herein. If multiple datasets of the radar data are available at different positions, the median may be used to suppress the objects. A precondition may be that there is more non-distorted radar data than radar data that is distorted by objects. Averaging may also at least reduce the influence of objects if only a few radar data are distorted by objects. The two methods can also be combined so that initially apparently distorted radar data is removed and then any remaining less distorted radar data is also removed using a median.

It can be assumed that the composition of the component will not substantially change over the different positions. The average value can additionally be used via the radar data. The robustness can thereby additionally be increased, inter alia by reducing the noise.

If representative radar data are now available for the composition of the component, they can be further processed in order to obtain the desired information about the composition of the component. There are various possible ways to do so, in particular the first and the second analysis methods according to exemplary embodiments of the disclosure. In a first possibility, or according to the first analysis method according to the disclosure, the composition of the component may be determined layer by layer. The component may comprise several layers 1 to n, with the thicknesses d₁ to dₙ. The radar data includes, in particular, reflections r₁ through rₙ of all layers. In the method according to exemplary embodiments, a reflection of the first layer r₁ may first be determined. From r₁, the permittivity of the first layer epsᵣ₁ may now be determined. A time difference dt₁₂ between the first and the second reflections may now be determined from the radar data, which corresponds in particular to a reflection on the front and the back of the first layer, respectively. A thickness of the first layer may now be determined from epsᵣ₁ and dt₁₂. Additionally, epsᵣ₁ may provide indications of a material of the first layer. In the next step, the first layer may be removed from the radar data. This may be achieved by analytically determining the scattering parameters of the first layer from the determined permittivities epsᵣ₁ and d₁, and then subtracting them from the output radar data after the method of the concatenated scattering parameters. What remains is in particular radar data corresponding to the composition of the component without the first layer. This radar data may now be used to proceed as originally with the first layer and so determine the parameters of the second layer. This may be continued until a termination criterion is met. The termination criterion may be, for example, a predefined maximum number of layers and/or a criterion depending on the size of the remaining radar data after deduction of all layers determined up to that point.

A further possibility is, in particular according to the second analysis method according to the disclosure, an iterative estimate of the composition of the component. To this end, a starting point may first be defined, i.e. a presumed composition of the component with n layers, the permittivities eps_{r1 . . . n} and the layer thicknesses d_{1 . . . n}. The scattering parameters may now be calculated from each layer and by concatenating theoretical radar data of this composition of the component. A measure of error may now be determined through comparison with the measured radar data. In addition, a direction of travel may now be determined from the error dimension, i.e., a change in the presumed composition of the component, which leads to a reduction in the error. This may be continued until the error falls below a defined maximum. Alternatively, by using more computational power, the errors of several different parameter sets (presumed compositions of the component) may be calculated and this operation may be continued with the smallest error starting from the current parameter set until a termination criterion is fulfilled, for example if the error is below a defined maximum or if a smallest change in the parameter set is achieved.

With regard to the second analysis method according to the disclosure, the difficulty may arise that many parameters must be considered at once. This can therefore be more suitable for cases in which advance information is already available and only a few layers are involved. In addition, it may be advantageous if the composition of the component contains thin layers such that they can no longer be resolved by the radar sensor. This may be problematic for the first analysis method according to the disclosure. One of the analysis methods may be selected based on these aspects.

Further, the composition of the component may be shown on a display. The composition of the component may be displayed in cross-section and relevant data may be supplemented, at least one thickness of each layer and optionally a permittivity or a material of a respective layer derived therefrom.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for determining a composition of a component, comprising:
providing radar data, wherein the radar data results from a detection of a sensor, wherein the sensor is disposed in an area of the component and emits a radar signal towards the component for the detection;
selecting an analysis method for determining the composition of the component as a function of a thickness of the component, and/or a number of layers, and/or a thickness of the layers of the component; and
determining the composition of the component using the selected analysis method,
wherein the selected analysis method for determining the composition of the component comprises:
detecting at least one reflection based on the provided radar data,
determining a permittivity and a thickness of at least one layer of the component based on the detected at least one reflection, and
providing a description of the at least one layer of the component based on the determined permittivity and thickness.

2. The method according to claim 1, further comprising:
initiating display of the determined summary on a display device, wherein the display comprises at least the thickness of the component, and/or the number of layers, and/or the thickness of the layers of the component.

3. The method according to claim 1, wherein a first analysis method for the selection comprises:
determining a reflection of a first layer of the component,
determining a permittivity of the first layer based on the determined reflection,
determining a time difference between the first and a second reflection,
determining a thickness of the first layer based on the determined permittivity and the determined time difference, and
removing a fraction of the radar data representing the first layer by determining scattering parameters of the first layer based on the determined permittivity and thickness of the first layer, and then subtracting said scattering parameters from concatenated radar data to obtain radar data representing the composition of the component without the first layer,
wherein the steps are repeated for further layers of the component until a defined termination criterion is met.

4. The method according to claim 3, wherein a material of the respective layer is additionally determined based on the determined permittivity.

5. The method according to claim 3, wherein the termination criterion is a predefined maximum number of layers and/or a criterion dependent on a size of the remaining radar data after deduction of all previously analyzed layers.

6. The method according to claim 3, wherein a second analysis method for the selection comprises:
defining a starting point, wherein the starting point is a presumed composition of the component having a defined number of layers with respective permittivity thicknesses of the layers,
calculating scattering parameters of each layer and concatenating the calculated scattering parameters to obtain theoretical radar data of the starting point,
comparing the theoretical radar data with the provided radar data to determine an error, and
determining a direction of travel based on the determined error, wherein the direction of travel represents a change in the starting point resulting in a reduction in the error,
wherein the steps are performed until the error falls below a defined maximum.

7. The method according to claim 6, wherein multiple starting points are defined and a respective error of the defined starting points is calculated, wherein starting from a starting point with a smallest calculated error, the steps of calculating the scattering parameters, comparing the theoretical radar data with the provided radar data, and determining the direction of travel are performed until the error falls below the defined maximum.

8. The method according to claim 1, wherein providing the radar data comprises:
detecting the radar data using the sensor, wherein the sensor is disposed in a range of the component and emits the radar signal towards the component for the detection,
analyzing the detected radar data to perform object detection in the component, and
discarding the detected radar data when a result of the analysis indicates that an object has been detected.

9. The method according to claim 1, wherein providing the radar data comprises:
detecting the radar data using the sensor, wherein the sensor is arranged sequentially in at least two positions in a region of the component and for the detection at the respective position emits the radar signal towards the component, and
calculating a mean and/or a median for the radar data detected at the at least two positions.

10. A computer program comprising instructions for causing the computer to carry out the method according to claim 1 when the computer program is executed by a computer.

11. An apparatus for data processing, configured so as to carry out the method according to claim 1.

12. A computer-readable storage medium comprising instructions which, when executed by a computer, cause it to carry out the steps of the method according to claim 1.

13. A locating device for determining a composition of a component comprising at least one sensor and a display device, wherein the locating device is configured to perform the method of claim 1.

14. The method according to claim 2, wherein the display further comprises a permittivity of a respective layer and/or a material of the respective layer determined based on the permittivity.

15. The method according to claim 1, wherein an analysis method for the selection comprises:
defining a starting point, wherein the starting point is a presumed composition of the component having a defined number of layers with respective permittivity thicknesses of the layers,
calculating scattering parameters of each layer and concatenating the calculated scattering parameters to obtain theoretical radar data of the starting point,
comparing the theoretical radar data with the provided radar data to determine an error, and
determining a direction of travel based on the determined error, wherein the direction of travel represents a change in the starting point resulting in a reduction in the error,
wherein the steps are performed until the error falls below a defined maximum.

16. The method according to claim 15, wherein multiple starting points are defined and a respective error of the defined starting points is calculated, wherein starting from a starting point with a smallest calculated error, the steps of calculating the scattering parameters, comparing the theoretical radar data with the provided radar data, and determining the direction of travel are performed until the error falls below the defined maximum.
